(19) United States
(12) Patent Application Publication
(10) Pub. No.: US 2022/0338014 A1
(43) Pub. Date: Oct. 20, 2022

(54) TRUSTWORTHINESS EVALUATION FOR GNSS-BASED LOCATION ESTIMATES

(71) Applicant: HERE Global B.V., Eindhoven (NL)

(72) Inventors: Marko Luomi, Lempaeaelae (FI); Tatiana Vyunova, Tampere (FI)

(21) Appl. No.: 17/301,779

(22) Filed: Apr. 14, 2021

(51) Int. Cl. H04W 12/63; H04W 12/69; H04W 12/108; H04W 12/60; G01S 19/07; G01S 19/01

(52) U.S. Cl. CPC H04W 12/63; H04W 12/69; H04W 12/108; H04W 12/66; G01S 19/074; G01S 19/015

(57) ABSTRACT

The disclosure provides methods, apparatus, and products for evaluating trustworthiness of GNSS-based location estimates. In one aspect, a method comprises obtaining observation information corresponding to one or more access points observed by a computing device during a time period; obtaining a GNSS-based location estimate indicating an estimated location of the computing device during at least a portion of the time period; determining an access points count corresponding to a number of the one or more observed access points that satisfy a distance criteria relative to the GNSS-based location estimate; comparing the determined access point count to a pre-defined threshold access points count; and based on results of the comparison, providing, by the processor, an indication of whether or not the GNSS-based location estimate is trustworthy. The method may be performed by one or more processors in a cloud-based computing system in response to an API call from the computing device.

### TECHNOLOGICAL FIELD

Example embodiments of the present disclosure relate generally to the field of positioning technologies. In particular, example embodiments generally relate to determining the trustworthiness of a GNSS-based location estimate.

### BACKGROUND

Global Navigation Satellite System (GNSS) receivers are common in many devices and allow a client apparatus to receive signals from GNSS satellites. Using such GNSS signals, client apparatuses can calculate a positional estimate based generally on orbital mechanics, signal transmission speed, triangulation, and timing and positioning data embedded in the GNSS signals. These calculations can be drastically and negatively affected when a client apparatus is spoofed, leading to inaccurate positional estimates. Spoofing can be generally defined as interfering with a Global Navigation Satellite System (GNSS) receiver to give faulty positioning estimates. Typically, spoofing involves a spoofer apparatus transmitting false GNSS signals to the GNSS receiver of a spoofing target, with the false GNSS signals configured to appear as legitimate GNSS signals. However, other spoofing can involve other methods of interfering with a target GNSS receiver. Spoofing is particularly problematic in various fields, such as but not limited to cybersecurity, clocking/timing, or autonomous vehicles. GNSS spoofing is also a large concern with many online applications and services that are location-aware.

### BRIEF SUMMARY

While calculating positional estimates via GNSS signals is widely favored and considered to be accurate with a high resolution, client apparatuses are also capable of calculating positional estimates through other methods, such as Wi-Fi positioning systems, cellular network positioning, and Bluetooth positioning, albeit all with varying degrees of accuracy and resolution. For example, Wi-Fi positioning involves measuring the intensity of a received Wi-Fi signal at a client apparatus and calculating a location estimate using metadata associated with a connected wireless access point. Other example positioning methods such as cellular network positioning and/or Bluetooth positioning may also generally involve observing signals (e.g., cell signals and Bluetooth signals, respectively) generated by access points (e.g., cellular and/or Bluetooth access points) at a client apparatus and calculating a location estimate using metadata associated with the access points transmitting said signals. A positioning database may store information regarding the location and/or coverage area of wireless access points. While some Wi-Fi, cellular, Bluetooth, and/or other access points have static positions, mobile hotspots and/or access points may have dynamic positions. In various embodiments, a positioning database may include even dynamic positions of such mobile access points, and such mobile access points may periodically update the positioning database with their dynamic positions. As such, Wi-Fi positioning, cellular positioning, Bluetooth positioning, and/or other radio signal observation-based positioning techniques provide modalities for determining positional estimates independent from GNSS positioning. While such positioning modalities may not have as high of a resolution as GNSS positioning, they may be used to verify GNSS positioning estimates to a degree of confidence or trustworthiness, as is provided in the present disclosure.

Client apparatuses that may be subject to GNSS spoofing can be exemplified in many forms such as personal cellular devices or autonomous vehicles, all of which have different computing and processing powers. Determining the trustworthiness of a GNSS-based location estimate is an additional method or process a client apparatus may perform in addition to the existing calculations for the original GNSS positioning estimate. As such, a cloud-based system or online application programming interface (API) for spoofing detection and GNSS signal verification bears clear technical advantages. For example, an online GNSS positioning estimate verification would conserve computing and processor power of the spoofing target. As another example, an online spoofing detection solution may aggregate data collected from a number of spoofing targets, or client apparatuses, and adapt spoofing detection strategies, such as via supervised machine learning models. For example, stricter trustworthiness criteria may be implemented in a specific area where multiple client apparatuses may be subject to GNSS spoofing.

Methods, apparatuses and computer program products are provided in accordance with example embodiments in order to provide in general an online evaluation of trustworthiness of a GNSS-based location estimate. Specifically, example embodiments provide an indication of whether or not a GNSS-based location estimate is trustworthy. In an example embodiment, a trustworthiness score or a confidence level in the trustworthiness of a GNSS-based positioning is determined. In general, example embodiments may communicate with an access point database (e.g., a Wi-Fi positioning database, cellular network database, Bluetooth database, and/or the like), or at least a network positioning database or method independent from the GNSS. In various embodiments, the determination of the trustworthiness of a GNSS-based location estimate is performed by an apparatus or a system different and/or separate from an apparatus receiving the GNSS signals. In an example embodiment, the determination of the trustworthiness of the GNSS-based location estimate is performed by the apparatus that received the GNSS signals.

In an example embodiment, a processor obtains observation information corresponding to one or more access points observed by a computing device during a time period. The processor also obtains a GNSS-based location estimate indicating an estimated location of the computing device during at least a portion of the time period. The processor determines an access point count corresponding to a number of the one or more observed access points that satisfy a distance criteria relative to the GNSS-based location estimate. The processor compares the determined access point count to a pre-defined threshold access point count, and based on the results of the comparison, provides an indication of whether or not the GNSS-based location estimate is trustworthy.

In an example embodiment, a computing device obtains observation information corresponding to one or more access points observed by the computing device during a time period. The computing device obtains a GNSS-based location estimate indicating an estimated location of the computing device during at least a portion of the time period. The computing device transmits a request for trustworthiness information indicating whether or not the GNSS-based location estimate is trustworthy to a cloud-based computing system. The request includes at least a portion of the observation information and the GNSS-based location estimate. In response to the request, the computing device receives the trustworthiness information provided and/or generated by the cloud-based computing system. The trustworthiness information is based at least on a comparison of (i) an access point count corresponding to a number of the one or more observed access points that satisfy a distance criteria relative to the GNSS-based location estimate, to (ii) a pre-defined threshold access point count.

In accordance with an aspect of the present disclosure, a method is provided. In an example embodiment, the method comprises obtaining, by a processor, observation information corresponding to one or more access points observed by a computing device during a time period; obtaining, by the processor, a GNSS-based location estimate indicating an estimated location of the computing device during at least a portion of the time period; determining, by the processor, an access point count corresponding to a number of the one or more observed access points that satisfy a distance criteria relative to the GNSS-based location estimate; comparing, by the processor, the determined access point count to a pre-defined threshold access point count; and based on results of the comparison, providing, by the processor, an indication of whether or not the GNSS-based location estimate is trustworthy. In an example embodiment, the one or more access points comprise at least one of: one or more Wi-Fi access points and the observation information comprises a media access control (MAC) address for each of the one or more Wi-Fi access points, one or more cellular network access points and the observation information comprises a cell ID, or one or more Bluetooth access points and the observation information comprises a universally unique identifier (UUID).

In an example embodiment, comparing the determined access point count to a pre-defined threshold access point count comprises determining an access point fraction based at least in part on a fraction defined by the number of the one or more observed access points that satisfy a distance criteria relative to the GNSS-based location estimate divided by the total number of one or more observed access points; and comparing the determined access point fraction to a pre-defined threshold fraction. In an example embodiment, the distance criteria corresponds to the respective distance of a respective access point of the one or more observed access points from the GNSS-based location estimate being less than a distance threshold.

In an example embodiment, at least one of the distance threshold or a length of the time period is determined based on movement information describing movement of the computing device during the time period. In an example embodiment, the distance threshold is determined for each access point of the one or more access points independently based on when during the time period the access point was observed by the computing device. In an example embodiment, the movement information is determined based on sensor data captured by one or more sensors of the computing device.

In an example embodiment, a location of an access point of the one or more observed access points is determined by accessing an access point database storing locations of a plurality of access points in association with respective observables that may be used to identify a corresponding access point of the plurality of access points. In an example embodiment, the processor is part of a cloud-based computing system, and the observation information and the GNSS-based location estimate is obtained via an application program interface (API) call generated by the computing device. In an example embodiment, the GNSS-based location estimate is determined by a GNSS sensor of the computing device. In an example embodiment, the processor is part of the computing device.

In an example embodiment, the indication of whether or not the GNSS-based location estimate is trustworthy is at least one of (a) a binary indication of whether or not the GNSS-based location estimate is trustworthy, or (b) a trustworthiness score indicating a determined confidence in the trustworthiness of the GNSS-based location estimate. In an example embodiment, an application operating on the computing device triggers the computing device to provide the observation information and the GNSS-based location estimate such that the processor obtains the observation information and the GNSS-based location estimate. In an example embodiment, at least one of (a) a length of the time period, (b) the distance criteria, or (c) the pre-defined threshold access point count is determined based on one or more location accuracy requirements of the application. In an example embodiment, the indication of whether or not the GNSS-based location estimate is trustworthy is configured to be used to determine whether the GNSS-based location estimate may be used to perform one or more positioning and/or navigation-related functions.

According to another aspect of the present disclosure, a system, comprising one or more servers each comprising at least one memory and at least one processor, is provided. The at least one memory stores instructions that, when executed by the at least one processor, cause the system to: obtain observation information corresponding to one or more access points observed by a computing device during a time period; obtain a GNSS-based location estimate indicating an estimated location of the computing device during at least a portion of the time period; determine an access point count corresponding to a number of the one or more observed access points that satisfy a distance criteria relative to the GNSS-based location estimate; compare the determined access point count to a pre-defined threshold access point count; and based on results of the comparison, provide an indication of whether or not the GNSS-based location estimate is trustworthy. In an example embodiment, the one or more access points comprise at least one of: one or more Wi-Fi access points and the observation information comprises a media access control (MAC) address for each of the one or more Wi-Fi access points, one or more cellular network access points and the observation information comprises a cell ID, or one or more Bluetooth access points and the observation information comprises a universally unique identifier (UUID).

In an example embodiment, comparing the determined access point count to a pre-defined threshold access point count comprises determining an access point fraction based at least in part on a fraction defined by the number of the one or more observed access points that satisfy a distance criteria relative to the GNSS-based location estimate divided by the total number of one or more observed access points; and comparing the determined access point fraction to a pre-defined threshold fraction. In an example embodiment, the distance criteria corresponds to the respective distance of a respective access point of the one or more observed access points from the GNSS-based location estimate being less than a distance threshold.

In an example embodiment, at least one of the distance threshold or a length of the time period is determined based on movement information describing movement of the computing device during the time period. In an example embodiment, the distance threshold is determined for each access point of the one or more access points independently based on when during the time period the access point was observed by the computing device. In an example embodiment, the movement information is determined based on sensor data captured by one or more sensors of the computing device.

In an example embodiment, a location of an access point of the one or more observed access points is determined by accessing an access point database storing locations of a plurality of access points in association with respective observables that may be used to identify a corresponding access point of the plurality of access points. In an example embodiment, the system is a cloud-based computing system and the observation information and the GNSS-based location estimate is obtained via an application program interface (API) call generated by the computing device. In an example embodiment, the GNSS-based location estimate is determined by a GNSS sensor of the computing device.

In an example embodiment, the indication of whether or not the GNSS-based location estimate is trustworthy is at least one of (a) a binary indication of whether or not the GNSS-based location estimate is trustworthy, or (b) a trustworthiness score indicating a determined confidence in the trustworthiness of the GNSS-based location estimate. In an example embodiment, an application operating on the computing device triggers the computing device to provide the observation information and the GNSS-based location estimate such that the system obtains the observation information and the GNSS-based location estimate. In an example embodiment, at least one of (a) a length of the time period, (b) the distance criteria, or (c) the pre-defined threshold access point count is determined based on one or more location accuracy requirements of the application. In an example embodiment, the indication of whether or not the GNSS-based location estimate is trustworthy is configured to be used to determine whether the GNSS-based location estimate may be used to perform one or more positioning and/or navigation-related functions.

In accordance with another example embodiment, a computer program product is provided that comprises at least one non-transitory computer-readable storage medium having computer-executable program code instructions stored therein. The computer-executable program code instructions comprise program code instructions configured to, when executed by a processor of an apparatus, cause the apparatus to obtain observation information corresponding to one or more access points observed by a computing device during a time period; obtain a GNSS-based location estimate indicating an estimated location of the computing device during at least a portion of the time period; determine an access point count corresponding to a number of the one or more observed access points that satisfy a distance criteria relative to the GNSS-based location estimate; compare the determined access point count to a pre-defined threshold access point count; and based on results of the comparison, provide an indication of whether or not the GNSS-based location estimate is trustworthy. In an example embodiment, the one or more access points comprise at least one of: one or more Wi-Fi access points and the observation information comprises a media access control (MAC) address for each of the one or more Wi-Fi access points, one or more cellular network access points and the observation information comprises a cell ID, or one or more Bluetooth access points and the observation information comprises a universally unique identifier (UUID).

In an example embodiment, comparing the determined access point count to a pre-defined threshold access point count comprises determining an access point fraction based at least in part on a fraction defined by the number of the one or more observed access points that satisfy a distance criteria relative to the GNSS-based location estimate divided by the total number of one or more observed access points; and comparing the determined access point fraction to a pre-defined threshold fraction. In an example embodiment, the distance criteria corresponds to the respective distance of a respective access point of the one or more observed access points from the GNSS-based location estimate being less than a distance threshold.

In an example embodiment, at least one of the distance threshold or a length of the time period is determined based on movement information describing movement of the computing device during the time period. In an example embodiment, the distance threshold is determined for each access point of the one or more access points independently based on when during the time period the access point was observed by the computing device. In an example embodiment, the movement information is determined based on sensor data captured by one or more sensors of the computing device.

In an example embodiment, a location of an access point of the one or more observed access points is determined by accessing an access point database storing locations of a plurality of access points in association with respective observables that may be used to identify a corresponding access point of the plurality of access points. In an example embodiment, the observation information and the GNSS-based location estimate is obtained via an application program interface (API) call generated by the computing device. In an example embodiment, the GNSS-based location estimate is determined by a GNSS sensor of the computing device.

In an example embodiment, the indication of whether or not the GNSS-based location estimate is trustworthy is at least one of (a) a binary indication of whether or not the GNSS-based location estimate is trustworthy, or (b) a trustworthiness score indicating a determined confidence in the trustworthiness of the GNSS-based location estimate. In an example embodiment, an application operating on the computing device triggers the computing device to provide the observation information and the GNSS-based location estimate such that the apparatus obtains the observation information and the GNSS-based location estimate. In an example embodiment, at least one of (a) a length of the time period, (b) the distance criteria, or (c) the pre-defined threshold access point count is determined based on one or more location accuracy requirements of the application. In an example embodiment, the indication of whether or not the GNSS-based location estimate is trustworthy is configured to be used to determine whether the GNSS-based location estimate may be used to perform one or more positioning and/or navigation-related functions.

In accordance with yet another aspect of the present disclosure, an apparatus is provided that comprises means for obtaining observation information corresponding to one or more access points observed by a computing device during a time period. The apparatus comprises means for obtaining a GNSS-based location estimate indicating an estimated location of the computing device during at least a portion of the time period. The apparatus comprises means for determining an access point count corresponding to a number of the one or more observed access points that satisfy a distance criteria relative to the GNSS-based location estimate. The apparatus comprises means for comparing the determined access point count to a pre-defined threshold access point count. The apparatus comprises means for, based on results of the comparison, providing an indication of whether or not the GNSS-based location estimate is trustworthy.

According to another aspect of the present disclosure, another method is provided. In an example embodiment, the method comprises obtaining, by a computing device, observation information corresponding to one or more access points observed by the computing device during a time period; obtaining, by the computing device, a GNSS-based location estimate indicating an estimated location of the computing device during at least a portion of the time period; transmitting, by the computing device to a cloud-based computing system, a request for trustworthiness information indicating whether or not the GNSS-based location estimate is trustworthy, the request including at least a portion of the observation information and the GNSS-based location estimate; and in response to the request, receiving, by the computing device from the cloud-based computing system, the trustworthiness information, wherein the trustworthiness information is based at least in part on a comparison of (i) an access point count corresponding to a number of the one or more observed access points that satisfy a distance criteria relative to the GNSS-based location estimate, to (ii) a pre-defined threshold access point count. In an example embodiment, the one or more access points comprise at least one of: one or more Wi-Fi access points and the observation information comprises a media access control (MAC) address for each of the one or more Wi-Fi access points, one or more cellular network access points and the observation information comprises a cell ID, or one or more Bluetooth access points and the observation information comprises a universally unique identifier (UUID).

In an example embodiment, the comparison of (i) an access point count corresponding to a number of the one or more observed access points that satisfy a distance criteria relative to the GNSS-based location estimate, to (ii) a pre-defined threshold access point count, comprises determining an access point fraction based at least in part on a fraction defined by the number of the one or more observed access points that satisfy a distance criteria relative to the GNSS-based location estimate divided by the total number of one or more observed access points; and comparing the determined access point fraction to a pre-defined threshold fraction. In an example embodiment, the distance criteria corresponds to the respective distance of a respective access point of the one or more observed access points from the GNSS-based location estimate being less than a distance threshold.

In an example embodiment, at least one of the distance threshold or a length of the time period is determined based on movement information describing movement of the computing device during the time period. In an example embodiment, the distance threshold is determined for each access point of the one or more access points independently based on when during the time period the access point was observed by the computing device. In an example embodiment, the movement information is determined based on sensor data captured by one or more sensors of the computing device. In an example embodiment, a location of an access point of the one or more observed access points is determined by accessing an access point database storing locations of a plurality of access points in association with respective observables that may be used to identify a corresponding access point of the plurality of access points. In an example embodiment, the GNSS-based location estimate is determined by a GNSS sensor of the computing device.

In an example embodiment, the trustworthiness information comprises at least one of (a) a binary indication of whether or not the GNSS-based location estimate is trustworthy, or (b) a trustworthiness score indicating a determined confidence in the trustworthiness of the GNSS-based location estimate. In an example embodiment, the transmitting, by the computing device to a cloud-based computing system, a request for trustworthiness information is triggered by an application operating on the computing device. In an example embodiment, at least one of (a) a length of the time period, (b) the distance criteria, or (c) the pre-defined threshold access point count is determined based on one or more location accuracy requirements of the application. In an example embodiment, the indication of whether or not the GNSS-based location estimate is trustworthy is configured to be used to determine whether the GNSS-based location estimate may be used to perform one or more positioning and/or navigation-related functions.

According to another aspect of the present disclosure, an apparatus comprising at least one memory and at least one processor is provided. For example, the apparatus is a computing device. The at least one memory stores instructions that, when executed by the at least one processor, cause the apparatus to: obtain observation information corresponding to one or more access points observed by the computing device during a time period; obtain a GNSS-based location estimate indicating an estimated location of the computing device during at least a portion of the time period; transmit, to a cloud-based computing system, a request for trustworthiness information indicating whether or not the GNSS-based location estimate is trustworthy, the request including at least a portion of the observation information and the GNSS-based location estimate; and in response to the request, receive, from the cloud-based computing system, the trustworthiness information, wherein the trustworthiness information is based at least in part on a comparison of (i) an access point count corresponding to a number of the one or more observed access points that satisfy a distance criteria relative to the GNSS-based location estimate, to (ii) a pre-defined threshold access point count. In an example embodiment, the one or more access points comprise at least one of: one or more Wi-Fi access points and the observation information comprises a media access control (MAC) address for each of the one or more Wi-Fi access points, one or more cellular network access points and the observation information comprises a cell ID, or one or more Bluetooth access points and the observation information comprises a universally unique identifier (UUID).

In an example embodiment, the comparison of (i) an access point count corresponding to a number of the one or more observed access points that satisfy a distance criteria relative to the GNSS-based location estimate, to (ii) a pre-defined threshold access point count, comprises determining an access point fraction based at least in part on a fraction defined by the number of the one or more observed access points that satisfy a distance criteria relative to the GNSS-based location estimate divided by the total number of one or more observed access points; and comparing the determined access point fraction to a pre-defined threshold fraction. In an example embodiment, the distance criteria corresponds to the respective distance of a respective access point of the one or more observed access points from the GNSS-based location estimate being less than a distance threshold.

In an example embodiment, at least one of the distance threshold or a length of the time period is determined based on movement information describing movement of the computing device during the time period. In an example embodiment, the distance threshold is determined for each access point of the one or more access points independently based on when during the time period the access point was observed by the computing device. In an example embodiment, the movement information is determined based on sensor data captured by one or more sensors of the computing device. In an example embodiment, a location of an access point of the one or more observed access points is determined by accessing an access point database storing locations of a plurality of access points in association with respective observables that may be used to identify a corresponding access point of the plurality of access points. In an example embodiment, the GNSS-based location estimate is determined by a GNSS sensor of the computing device.

In an example embodiment, the trustworthiness information comprises at least one of (a) a binary indication of whether or not the GNSS-based location estimate is trustworthy, or (b) a trustworthiness score indicating a determined confidence in the trustworthiness of the GNSS-based location estimate. In an example embodiment, the transmitting, by the computing device to a cloud-based computing system, a request for trustworthiness information is triggered by an application operating on the computing device. In an example embodiment, at least one of (a) a length of the time period, (b) the distance criteria, or (c) the pre-defined threshold access point count is determined based on one or more location accuracy requirements of the application. In an example embodiment, the indication of whether or not the GNSS-based location estimate is trustworthy is configured to be used to determine whether the GNSS-based location estimate may be used to perform one or more positioning and/or navigation-related functions.

In accordance with another example embodiment, a computer program product is provided that comprises at least one non-transitory computer-readable storage medium having computer-executable program code instructions stored therein. The computer-executable program code instructions comprise program code instructions configured to, when executed by a processor of an apparatus, cause the apparatus to: obtain observation information corresponding to one or more access points observed by the computing device during a time period; obtain a GNSS-based location estimate indicating an estimated location of the computing device during at least a portion of the time period; transmit, to a cloud-based computing system, a request for trustworthiness information indicating whether or not the GNSS-based location estimate is trustworthy, the request including at least a portion of the observation information and the GNSS-based location estimate; and in response to the request, receive, from the cloud-based computing system, the trustworthiness information, wherein the trustworthiness information is based at least in part on a comparison of (i) an access point count corresponding to a number of the one or more observed access points that satisfy a distance criteria relative to the GNSS-based location estimate, to (ii) a pre-defined threshold access point count. In an example embodiment, the one or more access points comprise at least one of: one or more Wi-Fi access points and the observation information comprises a media access control (MAC) address for each of the one or more Wi-Fi access points, one or more cellular network access points and the observation information comprises a cell ID, or one or more Bluetooth access points and the observation information comprises a universally unique identifier (UUID).

In an example embodiment, the comparison of (i) an access point count corresponding to a number of the one or more observed access points that satisfy a distance criteria relative to the GNSS-based location estimate, to (ii) a pre-defined threshold access point count, comprises determining an access point fraction based at least in part on a fraction defined by the number of the one or more observed access points that satisfy a distance criteria relative to the GNSS-based location estimate divided by the total number of one or more observed access points; and comparing the determined access point fraction to a pre-defined threshold fraction. In an example embodiment, the distance criteria corresponds to the respective distance of a respective access point of the one or more observed access points from the GNSS-based location estimate being less than a distance threshold.

In an example embodiment, at least one of the distance threshold or a length of the time period is determined based on movement information describing movement of the computing device during the time period. In an example embodiment, the distance threshold is determined for each access point of the one or more access points independently based on when during the time period the access point was observed by the computing device. In an example embodiment, the movement information is determined based on sensor data captured by one or more sensors of the computing device. In an example embodiment, a location of an access point of the one or more observed access points is determined by accessing an access point database storing locations of a plurality of access points in association with respective observables that may be used to identify a corresponding access point of the plurality of access points. In an example embodiment, the GNSS-based location estimate is determined by a GNSS sensor of the computing device.

In an example embodiment, the trustworthiness information comprises at least one of (a) a binary indication of whether or not the GNSS-based location estimate is trustworthy, or (b) a trustworthiness score indicating a determined confidence in the trustworthiness of the GNSS-based location estimate. In an example embodiment, the transmitting, by the computing device to a cloud-based computing system, a request for trustworthiness information is triggered by an application operating on the computing device. In an example embodiment, at least one of (a) a length of the time period, (b) the distance criteria, or (c) the pre-defined threshold access point count is determined based on one or more location accuracy requirements of the application. In an example embodiment, the indication of whether or not the GNSS-based location estimate is trustworthy is configured to be used to determine whether the GNSS-based location estimate may be used to perform one or more positioning and/or navigation-related functions.

In accordance with yet another aspect of the present disclosure, an apparatus, such as a computing device, for example, is provided. In an example embodiment, the apparatus comprises means for obtaining observation information corresponding to one or more access points observed by the apparatus during a time period. The apparatus comprises means for obtaining a GNSS-based location estimate indicating an estimated location of the apparatus during at least a portion of the time period. The apparatus comprises means for transmitting a request for trustworthiness information indicating whether or not the GNSS-based location estimate is trustworthy such that the request is received by a cloud-based computing system. The request includes at least a portion of the observation information and the GNSS-based location estimate. The apparatus comprises means for, in response to the request, receiving the trustworthiness information. The trustworthiness information is based at least in part on a comparison of (i) an access point count corresponding to a number of the one or more observed access points that satisfy a distance criteria relative to the GNSS-based location estimate, to (ii) a pre-defined threshold access point count.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2 is a block diagram of a system apparatus that may be specifically configured in accordance with an example embodiment;

FIG. 3 is a block diagram of a client apparatus that may be specifically configured in accordance with an example embodiment;

FIG. 4 is a block diagram of another client apparatus that may be specifically configured in accordance with an example embodiment;

FIG. 5 is a diagram illustrating a computing device positioned in an environment with access points, in accordance with an example embodiment;

FIG. 6 is a flowchart providing an example process for evaluating trustworthiness of a GNSS-based location estimate, in accordance with an example embodiment; and

FIG. 7 is a flowchart providing an example process for evaluating trustworthiness of a GNSS-based location estimate, in accordance with an example embodiment.

### DETAILED DESCRIPTION

Some embodiments will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

### I. Exemplary System

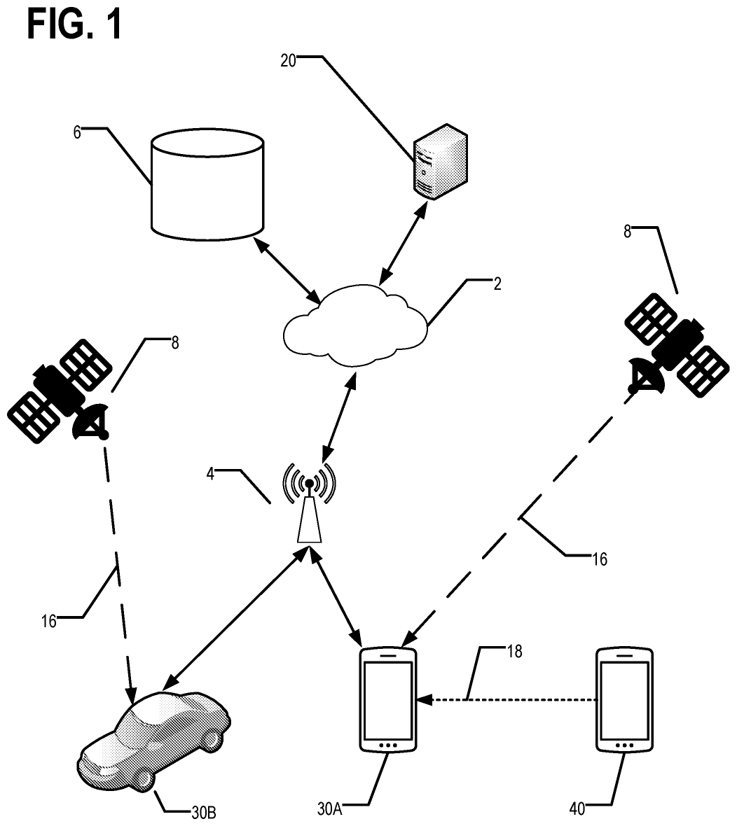

FIG. 1 provides an illustration of an example system that can be used in conjunction with various embodiments of the present disclosure. As shown in FIG. 1, the system may include a system apparatus 20 and one or more client apparatuses 30 (e.g., 30A, 30B). In various example embodiments, the system apparatus 20 is a cloud-based computing system comprising one or more computing apparatuses. In various embodiments, a spoofer apparatus 40 is located within a signal range of a client apparatus 30. The system apparatus 20, client apparatus 30, and/or the spoofer apparatus 40 may be embodied by or associated with a variety of computing devices including, for example, a navigation system including an in-vehicle navigation system, a vehicle control system, a personal navigation device (PND) or a portable navigation device, an advanced driver assistance system (ADAS), a global positioning system (GPS), a cellular telephone, a mobile phone, a personal digital assistant (PDA), a watch, a camera, a computer, server, server system, a personal computer, a computer workstation, a laptop computer, a plurality of networked computing devices, or the like. Specifically, the system apparatus 20 may be a server or server system configured to determine the trustworthiness of a GNSS-based location estimate. In an example embodiment, the client apparatus 30 may also be a computing device (e.g., a mobile computing device) configured to determine the trustworthiness of a GNSS-based location estimate. The client apparatus 30 may be a computing device capable of receiving GNSS signals 16 and spoofing signals 18, and the spoofer apparatus 40 may be a computing device configured to at least transmit spoofing signals 18 or otherwise interfere with client apparatus 30.

The client apparatus 30 (e.g., 30A, 30B) may be configured to receive GNSS signals 16 from GNSS satellites 8. GNSS satellites 8 may be associated with or a part of various GNSSs, such as US-based Global Positioning System (GPS), Russia-based Global Navigation Satellite System (GLONASS), EU-based Galileo, China-based BeiDou, Japan-based Quasi-Zenith Satellite System (QZSS), and Indian-based Navigation with Indian Constellation (NAVIC). As understood by those of skill in the art, GNSS signals 16 may be transmitted in different formats based on the GNSS to which they belong; however, GNSS signals 16 in general may comprise timing and positioning data configured to allow a GNSS receiver or an apparatus comprising a GNSS receiver to calculate a GNSS-based location estimate. A client apparatus 30 that is under a spoofing attack may receive spoofing signals 18 from a spoofer apparatus 40. For example, spoofing signals 18 transmitted by a spoofer apparatus 40 may closely resemble and attempt to appear as a legitimate GNSS signal 16. However, spoofing signals 18 may comprise inaccurate and/or false timing and positioning data configured to cause a GNSS receiver or an apparatus comprising a GNSS receiver to calculate an inaccurate and/or false location estimate. In various example embodiments, spoofing signals 18 interfere with GNSS signals 16 and cause the client apparatus 30 to not receive the accurate GNSS signals 16, or GNSS signals 16 at all. In various example embodiments, a GNSS satellite 8 may erroneously transmit inaccurate GNSS signals 16 with inaccurate timing and positioning data, causing the client apparatus 30 to calculate an inaccurate GNSS-based location estimate.

The client apparatus 30 may also be connected to a network 2 via one or more network access points 4. In various embodiments, the network 2 may be a Personal Area Network (PAN), Local Area Network (LAN), Metropolitan Area Network (MAN), Wide Area Network (WAN), Wi-Fi, Bluetooth, Bluetooth Low Energy (BLE), cellular network (3G/WDCMA/4G/LTE/5G/CAT M1), narrowband-internet of things (NB-IoT), and/or the like. In various embodiments, the network 2 is a wireless network 2. The network access point 4 may be a networking hardware device allowing the client apparatus 30 to connect to the network 2, such as a Wi-Fi router, a cellular network tower, and/or the like. In various embodiments, the client apparatus 30 may connect to the network 2 via one of a plurality of network access points 4. A network access point 4 may have parameters and characteristics stored in an access point database 6 corresponding to the network 2. In various embodiments, parameters and characteristics of a network access point 4 comprise a physical location of the network access point 4 (e.g., in the form of latitudinal and longitudinal coordinates) and identifiers identifying the network access point 4. In an example embodiment, the identifier of a network access point 4 may be observable by a client apparatus 30.

For example, an identifier of a network access point 4, such as an identifier stored in an access point database 6, may be a Service Set Identifier (SSID) and/or a media access control address (MAC address) where the network access point 4 is a Wi-Fi network access point. In an example embodiment, the access point database 6 is a Wi-Fi positioning database. In another example, the identifier of a network access point 4 may be a cell ID where the network access point 4 is a cell tower for a cellular network, and the access point database 6 is a cellular network database. In a further example, the identifier of a network access point 4 may be a universally unique identifier (UUID) where the network access point 4 is a Bluetooth access point, and the access point database 6 is a Bluetooth database. In various example embodiments, the access point database 6 stores the location and identifier of a network access point 4 in a format where the location and identifier are linked, such that by providing and/or searching for a specific identifier of a network access point 4, the access point database 6 provides a location for the network access point 4. For example, the access point database 6 may implement various models such as linked lists, trees, knowledge graphs, arrays, and/or other data structures such that an identifier and a location for a network access point 4 are related. In various example embodiments, the access point database 6 is a searchable database. In various example embodiments, the access point database 6 comprises an API, where an API response to an API call providing a network access point identifier includes a location for the corresponding network access point.

As aforementioned, FIG. 1 illustrates a system apparatus 20. The system apparatus 20 may be configured to determine the trustworthiness of a GNSS-based location estimate. In various embodiments, system apparatus 20 is configured in a cloud computing architecture distributed over multiple servers. In such embodiments, one or more system apparatuses 20 may be configured to determine the trustworthiness of a GNSS-based location estimate. For example, a network 2 may allow shared computer processing resources and data between any number of system apparatuses 20 connected thereto. In various example embodiments, system apparatus 20 is part of a cloud-based computing system. In an example embodiment, the system apparatus 20 is a cloud-based computing system communicating over a separate network from network 2. In an example embodiment, the system apparatus 20 comprises an online application programming interface (API). For example, the online API may be called by a connected client apparatus 30 (e.g., via the network 2), causing the system apparatus 20 to determine the trustworthiness of a GNSS-based location estimate and to respond with an API response (e.g., via the network 2) with an indication of the determined trustworthiness of the GNSS-based location estimate. The system apparatus 20 may communicate with the access point database 6 via the network 2.

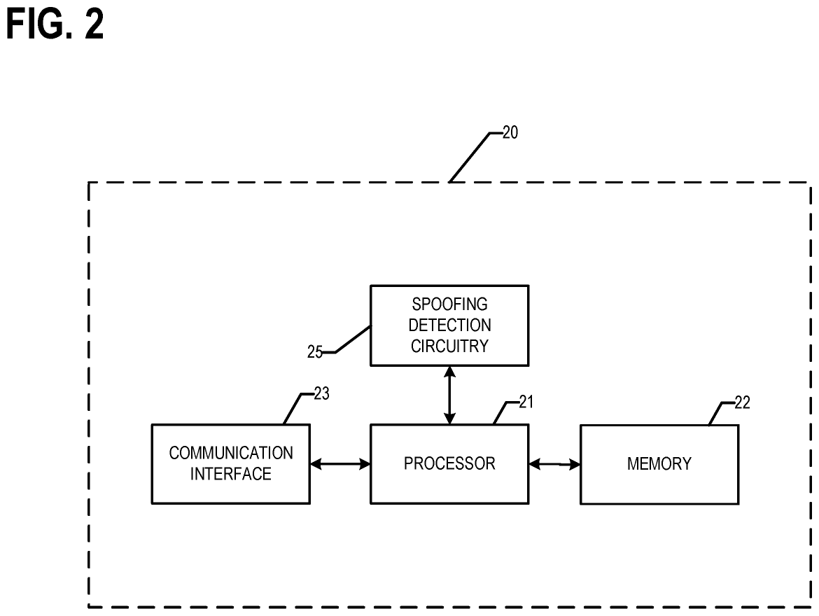

A system apparatus 20 may comprise components similar to those shown in the example embodiment of a system apparatus 20 diagrammed in FIG. 2. The system apparatus 20 may comprise a processor 21, a memory 22, a communication interface 23, spoofing detection circuitry 25, and/or other components configured to perform various operations, procedures, functions or the like described herein. A system apparatus 20 may comprise means for determining the trustworthiness of a GNSS-based location estimate. For example, the system apparatus 20 comprises means for obtaining observation information corresponding to one or more access points observed by a computing device during a time period and obtaining a GNSS-based location estimate indicating an estimated location of a client apparatus 30 during at least a portion of the time period. The system apparatus 20 may further comprise means for determining an access point count corresponding to a number of the one or more observed access points that satisfy a distance criteria relative to the GNSS-based location estimate, comparing the determined access point count to a pre-defined threshold access points count, and based on results of the comparing, providing an indication of whether or not the GNSS-based location estimate is trustworthy.

In various example embodiments, spoofing detection circuitry 25 may be configured to determine the trustworthiness of a GNSS-based location estimate. For example, spoofing detection circuitry 25 may be configured to determine an access point count corresponding to a number of one or more observed access points that satisfy a distance criteria relative to a GNSS-based location estimate, compare the determined access point count to a pre-defined threshold access point count, and based on results of the comparison, provide an indication of whether or not the GNSS-based location estimate is trustworthy.

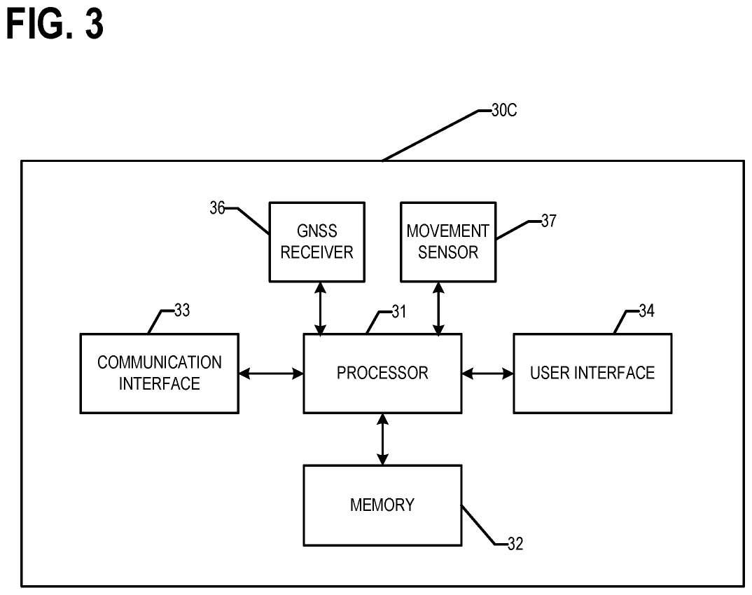

In an example embodiment, a client apparatus 30 may comprise components similar to those shown in the example client apparatus 30C diagrammed in FIG. 3. The client apparatus 30C may comprise a processor 31, a memory 32, a communication interface 33, a user interface 34, a GNSS receiver 36, a movement sensor 37, and/or other components configured to perform various operations, procedures, functions and/or the like described herein. A client apparatus 30 may comprise means for requesting and receiving trustworthiness information. For example, the client apparatus 30 comprises means for obtaining observation information corresponding to one or more access points observed by a computing device during a time period and obtaining a GNSS-based location estimate indicating an estimated location of the client apparatus 30 during at least a portion of the time period. The client apparatus 30 may further comprise means for transmitting a request for trustworthiness information for a GNSS-based location estimate, the request including at least a portion of the observation information and the GNSS-based location estimate, and in response to the request, receiving the trustworthiness information.

As illustrated in FIG. 3, the client apparatus 30C may comprise a GNSS receiver 36. The GNSS receiver 36 may be configured to receive GNSS signals 16 from a GNSS satellite 8. The GNSS receiver 36 may also receive spoofing signals 18 from a spoofer apparatus 40, due to, in some embodiments, similarities between spoofing signals 18 and GNSS signals 16. Similarly, the GNSS receiver 36 may receive GNSS signals 16 that may be interfered with by spoofing signals 18. The GNSS receiver 36 may be circuitry configured to receive and process GNSS signals 16 or spoofing signals 18. For example, the GNSS receiver 36 may be a hardware GNSS receiver on a dedicated chip. In an example embodiment, the GNSS receiver 36 may comprise a software-defined receiver or a software-designed radio. The GNSS receiver 36 may comprise an antenna and a dedicating processing unit separate from processor 31. In various embodiments, the GNSS receiver 36 is an antenna, and the processor 31 is configured to process received signals from the GNSS receiver 36.

The movement sensor 37 may be configured to obtain movement information describing movement of a client apparatus 30. The movement sensor 37 may be one or more sensors configured to capture movement information. For example, the movement sensor 37 may comprise one or more of an accelerometer, gyroscope, inertial measurement unit (IMU) and/or other devices configured to capture movement information of the client apparatus 30.

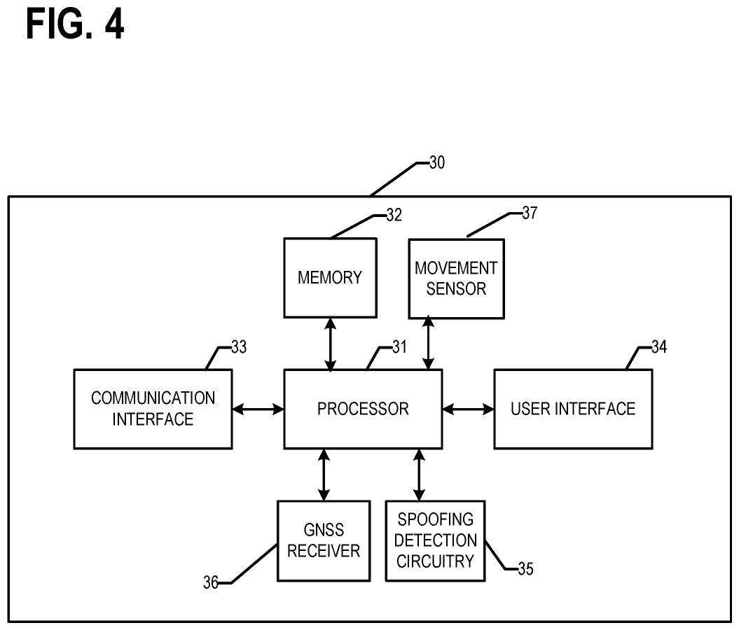

In an example embodiment, a client apparatus 30 comprises components similar to those shown in the example client apparatus 30D diagrammed in FIG. 4. Client apparatus 30D may comprise components similar to those shown in the example client apparatus 30C as shown in FIG. 3, such as a processor 31, a memory 32, a communication interface 33, a user interface 34, a GNSS receiver 36, and a movement sensor 37. Client apparatus 30D may further comprise spoofing detection circuitry 35. Spoofing detection circuitry 35 in client apparatus 30D may be similar to spoofing detection circuitry 25 in system apparatus 20. For example, spoofing detection circuitry 35 is configured to determine an access point count corresponding to a number of one or more observed access points that satisfy a distance criteria relative to a GNSS-based location estimate, compare the determined access point count to a pre-defined threshold access point count, and based on results of the comparison, provide an indication of whether or not the GNSS-based location estimate is trustworthy.

### II. Exemplary Operations

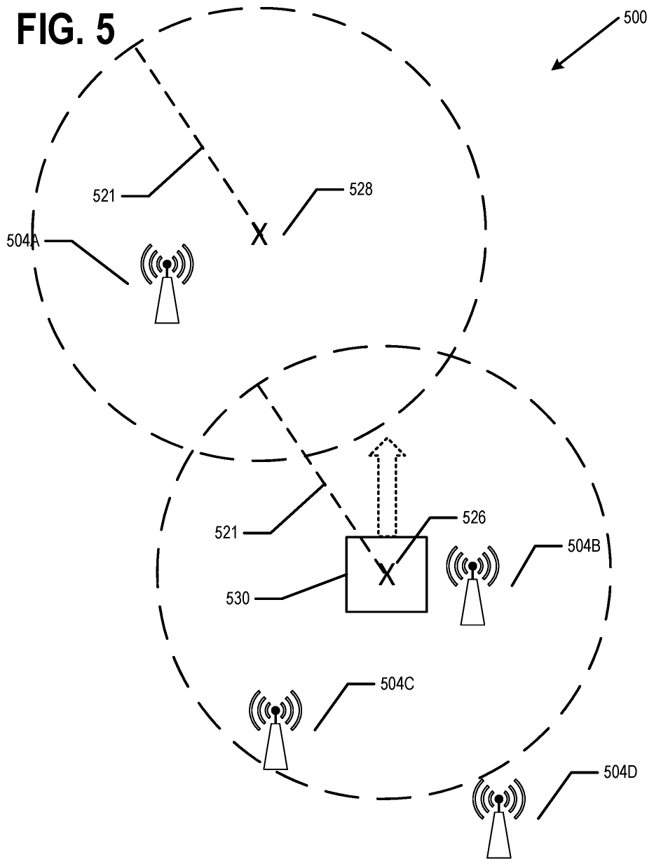

Referring now to FIG. 5, a diagram 500 illustrating a client apparatus 530 located in an environment with network access points 504A, 504B, 504C, 504D is provided. The diagram 500 can be interpreted as a top-down perspective of a client apparatus 530 at a location 526 and the surrounding environment. As a non-limiting example, diagram 500 is oriented so that a direction towards the top of the page (such as the dotted arrow indicating the direction of travel of the client apparatus 530) can be considered northbound, with other cardinalities being relative to the northbound direction. Diagram 500 illustrates four network access points 504A-D located at various distances from the client apparatus 530. Diagram 500 also illustrates an example spoofed location 528.

In diagram 500, each network access point 504A-D may be in communication with a network 2 (e.g., a Wi-Fi network, a cellular network, a Bluetooth network), where the network 2 may comprise and/or be in communication with an access point database 6. As previously mentioned, the access point database 6 may store data such as parameters and characteristics of each network access point 504. Most notably, the access point database 6 may store a location and an identifier (e.g., a MAC address, a cell ID) for each network access point 504. The location for each network access point 504 may be latitudinal and longitudinal coordinates, or an indication of location in a similar format to a GNSS-based location estimate.

Client apparatus 530 may obtain observation information corresponding to one or more network access points observed during a time period. For example, client apparatus 530 is capable of observing or configured to observe one or more network access points 504. For example, client apparatus 530 actively scans available frequencies for network access points 504 and receives response frames from network access points 504. The response frames received by client apparatus 530 and transmitted from a network access point 504 may comprise an identifier for the network access point 504, such as a MAC address if the network access point 504 is a Wi-Fi access point, a cell ID if the network access point 504 is a cellular network access point, or a UUID if the network access point 504 is a Bluetooth access point. In various embodiments, the client apparatus 530 is capable of observing radio frequency signals (e.g., Wi-Fi, cellular, Bluetooth, and/or the like) above a respective signal-type threshold signal strength level at the location of the client apparatus. For example, in diagram 500, client apparatus 530 may not obtain observation information corresponding to network access point 504A due to network access point 504A being located far enough from the client apparatus 530 such that the signal strength of a signal generated by the network access point 504A is below the respective signal-type threshold signal strength level at the location 526 of the client apparatus 530. Client apparatus 530 may also be connected to a network 2, via a connected network access point 504B. In various example embodiments, the client apparatus 530 may be aware of a MAC address, or any other unique identifier for the connected network access point 504B. Thus, as the signal strength of a signal generated by network access point 504B is above the respective signal-type threshold signal strength level at the location of the client apparatus 530, the client apparatus observes the network access point 504B. The client apparatus 530 may also observe (e.g., detect, receive, capture, measure, and/or the like a signal generated by) network access point 504C.

In example embodiments where the network access points 504 are Wi-Fi access points, the client apparatus 530 stores observation information comprising at least one of an SSID and a MAC address for each observed and connected network access point 504. In example embodiments where the network access points 504 are cellular network access points, the client apparatus 530 stores observation information comprising a cell ID for each observed and connected network access point 504. In example embodiments where the network access points 504 are Bluetooth access points, the client apparatus 530 stores observation information comprising a universally unique identifier (UUID) for each observed and connected network access point 504.

Observation information may only correspond to network access points 504 observed and/or connected to within a time period. For example, observation information is stored in a temporary manner, wherein observation information corresponding to network access points 504 observed outside a time period may be deleted, cached, relocated, or otherwise not presently available. For example, the client apparatus 530 comprises an observation buffer, where only a number of observed network access points 504 are stored and subsequently observed network access points 504 may “push” or replace network access points 504 in the buffer (e.g., in a first in-first out (FIFO) manner).

In various example embodiments, the observational time period may be determined based on the movement of the client apparatus 530 (e.g., determined via a movement sensor 37). For example, the observational time period may be longer when the client apparatus 530 is in a high motion state, potentially resulting in the observation information corresponding to a larger number of network access points 504. For example, in a scenario where the client apparatus 530 is not moving or is moving at a speed corresponding to walking, for example, the time period is longer than in a scenario where the client apparatus 530 is moving at a speed corresponding to highway travel, in an example embodiment. For example, in the scenario where the client apparatus 530 is not moving or is moving at a speed corresponding to walking, the time period is five minutes long, while in the scenario where the client apparatus 530 is moving at a speed corresponding to highway travel, the time period is one minute long, in an example embodiment. For example, in an example embodiment, the time period is configured such that the client apparatus 530 has not moved more than a particular distance during the time period. In various embodiments, the particular distance may be half a kilometer, one kilometer, two kilometers, half a mile, one mile, two miles, and/or the like.

Meanwhile, client apparatus 530 may be configured to obtain a GNSS-based location estimate indicating an estimated location of client apparatus 530. For example, client apparatus 530 is configured to receive GNSS signals 16 (e.g., via a GNSS receiver 36) and calculates a GNSS-based location estimate. In a first exemplary scenario, client apparatus 530 receives GNSS signals 16 from GNSS satellites 8, and calculates a GNSS-based location estimate for location 526. As illustrated in diagram 500, the unspoofed GNSS-based location estimate for location 526 may be accurate within a margin of error for the actual location of client apparatus 530, potentially due to e.g., interference with nearby structures, calculation margins of a GNSS receiver 36, clock errors in a GNSS receiver 36, atmospheric effects with a GNSS satellite 8, and clock errors in a GNSS satellite 8. However, it will be understood that such a margin of error is a standard and accepted margin of error when calculating a GNSS-based location estimate.

The client apparatus 530 may transmit a request for trustworthiness information such that a system apparatus 20 receives the request for trustworthiness information. As aforementioned, system apparatus 20 may be a cloud-based computing system, and the request for trustworthiness information may be received by one or more processors in the cloud-based computing system. The client apparatus 530 may also transmit the observation information corresponding to the observed network access points 504B, 504C (e.g., identifiers configured to identify the observed network access points) such that a system apparatus 20, or one or more processors in system apparatus 20, receives the observation information. The client apparatus 530 may also transmit the GNSS-based location estimate, such as location 526, such that the system apparatus 20, or one or more processors in system apparatus 20, receives the GNSS-based location estimate. In various example embodiments, the request for trustworthiness information includes at least a portion of the observation information and the GNSS-based location estimate, such as location 526. In an example embodiment, client apparatus 530 may be in communication with the system apparatus 20 via a connected network access point 504. In another example embodiment, client apparatus 530 may be in communication with the system apparatus 20 via a different network. For example, the client apparatus 530 may communicate with the system apparatus 20 via a Wi-Fi network while only obtaining observation data for cellular network access points. The observation information and the GNSS-based location estimate (e.g., location 526) may be transmitted by the client apparatus 530 as a result of a trigger by an application operating on and/or being executed by the client apparatus 530. For example, an accurate location estimate may be important or critical to an online application operating on and/or being executed by the client apparatus 530 (e.g., a navigation application), and the online application triggers the client apparatus 530 to transmit the request for trustworthiness information in order to receive trustworthiness information for the GNSS-based location estimate of location 526. In an example embodiment, the client apparatus 530 calls an online API of the system apparatus 20, and the system apparatus 20 obtains the observation information and the GNSS-based location estimate (e.g., location 526) via the online API call.

The system apparatus 20 may then determine an access point count corresponding to a number of the one or more observed access points that satisfy a distance criteria relative to the GNSS-based location estimate (e.g., location 526). In various example embodiments, the distance criteria comprises a distance threshold 521. For example, the distance criteria is satisfied for an access point 504, in an example embodiment, when the access point 504 is located within the distance threshold 521 of the GNSS-based location estimate of location 526. In various example embodiments, the system apparatus 20 determines a number of the network access points 504 corresponding to the received observation information that are located at a respective distance from the GNSS-based location estimate less than the distance threshold 521. The system apparatus 20 may be configured to access an access point database 6 storing identifiers and locations of network access points 504. The system apparatus 20 may be configured to identify locations of network access points 504 in the access point database 6 using identifiers of network access points 504 (e.g., MAC address for Wi-Fi access points, cell ID for cellular network access points, and/or UUID for Bluetooth access points) received in the observation information. In various example embodiments, accessing the access point database 6 comprises extracting an identifier, or any other respective observables, of a network access point 504 from the observation information, locating a matching identifier stored in the access point database 6 (e.g., by querying the database using an identifier extracted from the observation information), and identifying a location corresponding to the located identifier and the network access point 504. In an example embodiment, the system apparatus 20 communicates with the access point database 6 via an API, where the system apparatus 20 calls an access point database API with an identifier for a network access point 504 and receives an API response from the access point database 6 with the location of the network access point 504.

In an example embodiment, the distance threshold 521 may be a fixed or pre-defined distance. For example, the distance threshold 521 may be determined independently of when during the observation time period a network access point 504 was observed by the client apparatus 30. In another example embodiment, the distance threshold 521 may be unique for each network access point 504 based at least in part on when each network access point 504 was observed and movement of the client apparatus 530. In such an embodiment, the system apparatus 20 may determine a number of the network access points 504 corresponding to the received observation information that are located at a respective distance from the GNSS-based location less than a corresponding/respective distance threshold 521. For example, a distance threshold 521 for network access point 504D may be greater than a distance threshold 521 for network access point 504B, due to network access point 504D being observed at an earlier point in time than network access point 504B. In another example, distance threshold 521 for each network access point 504 may be increased if the client apparatus 530 was in a movement state during at least the observational time period. In an example embodiment, distance threshold 521 may be determined based on one or more location accuracy requirements of an application operating on and/or being executed by the client apparatus 530 and requesting the trustworthiness information.

In various example embodiments, the system apparatus 20 may determine a number or count of observed network access points 504 satisfying the distance criteria. For example, the distance criteria is satisfied for an access point 504, in an example embodiment, when the access point 504 is located within the distance threshold 521 of the GNSS-based location estimate (e.g., location 526). For example, the access point count may be an integer number of observed network access points 504 satisfying the distance criteria, where the integer number may be less than or equal to the integer number of total observed network access points 504. In the illustrated embodiment in FIG. 5, a determined access point count is 2; that is, two access points (504B, 504C) satisfy a distance criteria (e.g., fixed distance threshold 521) relative to the GNSS-based location estimate of location 526. In various other example embodiment, the system apparatus 20 may determine an access point fraction, and/or the access point count may comprise an access point fraction. For example, an access point fraction is based at least in part on a fraction defined by the number of observed network access points 504 satisfying the distance criteria relative to the GNSS-based location estimate of location 526 divided by the total number of observed network access points, in an example embodiment. Returning to the illustrated embodiment in FIG. 5, a determined access point fraction is ⅔; that is, two access points (504B, 504C) out of three observed access points (504B-D) satisfy a distance criteria (e.g., fixed distance threshold 521) relative to the GNSS-based location estimate of location 526. An access point fraction may be otherwise understood as a ratio of observed network access points 504 satisfying the distance criteria to total observed network access points 504. In various example embodiments, the system apparatus 20 determines an access point count comprising both a number of observed network access point 504 satisfying the distance criteria and an access point fraction.

In various example embodiments, the access point database 6 may not store a corresponding location for a network access point 504, may not store an identifier for a network access point 504, or otherwise may not store any information for a network access point 504. For example, the system apparatus 20 may not be able to determine whether a network access point 504 that is unknown to the access point database 6 satisfies a distance criteria (is located with a distance threshold 521 of the GNSS-based location estimate, such as location 526) due to possibly not being able to obtain a location for the network access point 504 or reference information associated with the network access point 504 stored in the access point database 6. For example, the system apparatus 20 may request a location for a network access point 504 unknown to the access point database 6 via an API call, and the system apparatus 20 subsequently receives an API response indicating an error. In an example embodiment, a client apparatus 530 may obtain incorrect, erroneous, or corrupted observation information for a network access point 504, and the system apparatus 20 is not able to obtain a location for the network access point 504 due to an incorrect identifier. In such situations, the one or more observed network access points 504 may comprise a number of observed network access points 504 unknown to the access point database 6. In various example embodiments, the number of observed network access points 504 unknown to the access point database 6 may be excluded from the calculation of an access point fraction (e.g., the number of unknown network access points may be subtracted from both the numerator and denominator in the access point fraction). In various example embodiments, the number of observed network access points 504 unknown to the access point database 6 may be excluded from the determined access point count corresponding to a number of the one or more observed access points that satisfy a distance criteria relative to the GNSS-based location estimate (e.g., location 526).

In various example embodiments, the system apparatus 20 then compares the determined access point count to a pre-defined threshold access point count. The pre-defined threshold access point count may be based at least in part on one or more location accuracy requirements of an application operating on and/or being executed by client apparatus 530 and requesting the trustworthiness information. In various example embodiments, the pre-defined threshold access point count comprises a pre-defined threshold fraction. In various example embodiments, the pre-defined threshold access point count may be determined based at least in part on desired sensitivity, specificity, positive predictive values (PPV), negative predictive values (NPV), and/or values that may otherwise weigh fractions of true positives, false positives, true negatives, and false negatives. For example, the pre-defined threshold access point count is adjusted to be higher when a high number of false positive trustworthiness results are reported, false positives suggesting that a GNSS-based location estimate may be determined (e.g., by the system apparatus 20) to be trustworthy when in fact the GNSS-based location estimate is not trustworthy. The pre-defined threshold access point count may be otherwise adjusted based on a reported number of true positives, false positives, true negatives, false negatives, or sensitivity, specificity, positive predictive values and negative predictive values.

In various example embodiments, the pre-defined threshold access point adjusts automatically using machine learning methods. For example, training sets of trustworthy and un-trustworthy GNSS-based location estimates with corresponding access point counts are given to a supervised machine learning model to define a threshold access point count. In various example embodiments, training data for supervised machine learning models for defining a threshold access point count are obtained from multiple different client apparatuses 530 that may communicate with a system apparatus 20. In other various example embodiments, training data for supervised machine learning models for defining a threshold access point count may be obtained only from one client apparatus 530 where the threshold access point count will be used, meaning each client apparatus 530 defines a separately trained threshold access point count.

The system apparatus 20 may then provide an indication of whether or not the GNSS-based location estimate is trustworthy based on the results of the comparison. For example, the GNSS-based location estimate of location 526 is determined to be trustworthy if the determined access point count is greater than or equal to a pre-defined threshold access point count. For example, in an example embodiment, when the access point count is two or greater, the GNSS-based location estimate is determined to be trustworthy. In the illustrated embodiment of FIG. 5, for example, the determined access point count is 2 due to access points 504B and 504C satisfying distance criteria relative to the GNSS-based location estimate of location 526, and the GNSS-based location estimate of location 526 is determined to be trustworthy. Likewise, the GNSS-based location estimate may be determined to be un-trustworthy when the determined access point count is less than a pre-defined threshold access point count. For example, in an example embodiment, when the access point count is less than two, the GNSS-based location estimate is determined to be un-trustworthy. In various example embodiments, the determined access point count comprises an access point fraction, and the GNSS-based location estimate is determined to be trustworthy or not based on a comparison of the access point fraction with a pre-defined threshold fraction. In various example embodiments, the GNSS-based location estimate is determined to be trustworthy or not based on both a comparison of the determined access point count with the pre-defined threshold access point count and a comparison of an access point fraction with a pre-defined threshold access point fraction.

In various example embodiments, the indication of whether or not the GNSS-based location estimate is trustworthy or not may be a binary indication or a trustworthiness score. In other words, the provided trustworthiness information may be and/or comprise one of, or both of: (a) a binary indication of whether or not the GNSS-based location estimate is trustworthy, and (b) a trustworthiness score indicating a determined confidence in the trustworthiness of the GNSS-based location estimate. For example, the binary indication may be either the GNSS-based location is trustworthy or the GNSS-based location is not trustworthy. Meanwhile, a trustworthiness score may be a numerical score within a score range indicating a determined confidence of trustworthiness. The binary indication may be determined based on a logical comparison (e.g., greater than, less than, equal to) of the access point count to the pre-defined access point count. The trustworthiness score may be determined based on pre-defined threshold access point count ranges. For example, the trustworthiness score may be, or may be determined based at least on, the access point fraction, a fraction of access points located within the distance threshold of the GNSS-based location estimate that were observed by the client apparatus 530 (e.g., as indicated by the observation information), and/or the like. As a non-limiting example, the trustworthiness score may range from 1-5, and each score (e.g., 1, 2, 3, 4, and 5) may be associated with a pre-defined threshold access point count range. In an example embodiment, the trustworthiness score may be determined based on a statistical standard deviation of the determined access point count from a pre-defined threshold access point count, where a standard deviation may be determined from a population of previously-determined access point counts. For example, a determined access point count that is greater than 2 standard deviations away from the pre-defined threshold access point count may result in a relatively low trustworthiness score. In various example embodiments, the trustworthiness score may be determined based on pre-defined threshold access point fraction ranges. In various example embodiments, the system apparatus 20 may provide the trustworthiness information via an online API response to the original online API call by the client apparatus 530 requesting trustworthiness information. In various example embodiments, trustworthiness criteria (e.g., the pre-defined threshold access point count and/or pre-defined threshold fraction) may be determined based on one or more location accuracy requirements of an application operating on and/or being executed by the client apparatus 530.

It will be appreciated then that at least four different types of trustworthiness information may be provided by the system apparatus 20, in various embodiments, the at least four including: (i) binary indication based on a number of satisfactory network access points, (ii) binary indication based on a fraction of satisfactory network access points out of observed network access points, (iii) trustworthiness score based on a number of satisfactory network access points, and (iv) trustworthiness score based on a fraction of satisfactory network access points out of observed network access points. In various example embodiments, the trustworthiness information may comprise any combination of, and/or all of the aforementioned.

In various example embodiments, the client apparatus 530, in response to the request for trustworthiness information, receives, from the system apparatus 20, the trustworthiness information, where the trustworthiness information may be the provided indication of whether or not the GNSS-based location estimate (e.g., location 526) is trustworthy. As aforementioned, system apparatus 20 may be a cloud-based computing system, and the client apparatus 530 may receive the trustworthiness information from the cloud-based computing system. In various example embodiments, the client apparatus 530 provides the trustworthiness information to an application operating on and/or being executed by the client apparatus 530 and requesting the trustworthiness information. In various example embodiments, the trustworthiness information may be used by the client apparatus 530, and/or an application operating on the client apparatus 530, to determine whether the GNSS-based location estimate may be used to perform one or more positioning and/or navigation-related functions. For example, the trustworthiness information may comprise a trustworthiness score, and determining whether the GNSS-based location estimate may be used to perform one or more positioning and/or navigation-related functions may comprise comparing the trustworthiness score to a pre-defined threshold trustworthiness score. In other example embodiments, the trustworthiness information may comprise a binary indication. In various example embodiments, determining whether the GNSS-based location estimate may be used to perform one or more positioning and/or navigation-related functions may comprise both evaluating a binary indication and comparing a trustworthiness score to a pre-defined threshold trustworthiness score. In various example embodiments, the pre-defined threshold trustworthiness score may be determined based on machine learning, such as supervised machine learning models.

In various example embodiments, receiving the trustworthiness information comprises the displaying (e.g., via a user interface 34) of the trustworthiness information for a user of the client apparatus 530. In various example embodiments, determining whether the GNSS-based location estimate (e.g., location 526) may be used to perform one or more positioning and/or navigation-related functions may be based at least in part on input from a user of the client apparatus 530 subsequent to the display of the trustworthiness information. In various embodiments, receiving the trustworthiness information comprises providing the trustworthiness information (or the GNSS-based location estimate if the trustworthiness information indicates that it is trustworthy) to an application operating on and/or being executed by the client apparatus 530. For example, the application operating on and/or being executed by the client apparatus 530 may use the GNSS-based location estimate that was determined to be trustworthy to perform one or more positioning and/or navigation-related functions. Some non-limiting examples of positioning-related and/or navigation-related functions include localization, provision of location dependent and/or triggered information, route determination, lane level route determination, operating a vehicle along a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, provision of safety alerts, and/or the like.

In various example embodiments, client apparatus 530 may obtain an inaccurate GNSS-based location estimate and be unaware of whether the GNSS-based location estimate is inaccurate or not. For example, client apparatus 530 may be targeted by a spoofer apparatus 40 and receive spoofing signals 18. Likewise, a spoofer apparatus 40 may transmit spoofing signals 18 to interfere with GNSS signals 16 received by the client apparatus 530. Further, one or more GNSS satellites 8 may, inadvertently or be maliciously caused to, transmit inaccurate GNSS signals 16 with inaccurate timing and positioning data, causing client apparatus 530 to obtain an inaccurate GNSS-based location estimate. For example, the client apparatus 530 obtains an inaccurate GNSS-based location estimate, such as an estimate for spoofed location 528. Client apparatus 530 may be unaware of whether the GNSS-based location estimate of spoofed location 528 is trustworthy or not. As discussed in context of the aforementioned examples, the client apparatus 530 may transmit observation information and the GNSS-based location estimate of spoofed location 528, such that the system apparatus 20 obtains (e.g., receives) the observation information and the GNSS-based location estimate. Again, system apparatus 20 may reference an access point database 6 for location data for each observed network access point 504, such as network access points 504B-D. Meanwhile, network access point 504A, which is unobserved by client apparatus 530, is the only network access point near spoofed location 528, or otherwise satisfying a distance criteria relative to spoofed location 528. As is clear from diagram 500, observed network access points 504B-D are located at locations that may be greater than distance thresholds 521 (e.g., a fixed distance threshold 521 or corresponding/relative distance thresholds 521 for each network access point 504B-D) and thus do not satisfy the distance criteria with respect to spoofed location 528. As will be appreciated then, a determined access point count (e.g., one(1)) for the GNSS-based location estimate for spoofed location 528 may be less than the pre-defined threshold access point count, based on diagram 500. For example, the determined access point count for the GNSS-based location estimate for spoofed location 528 may be one (for access point 504A), and the pre-defined threshold count may be two. As such, system apparatus 20 may provide an indication that the GNSS-based location estimate for spoofed location 528 is not trustworthy, which may comprise a binary indication of un-trustworthiness and/or a relatively low trustworthiness score.

System apparatus 20 may further implement machine learning models (e.g., supervised machine learning) with aggregated data from multiple client apparatuses 530 and adapt trustworthiness determination strategies (e.g., distance criteria, trustworthiness criteria). In the aforementioned example, client apparatus 530 is targeted by a spoofer apparatus 40, due to the spoofer apparatus 40 being located in a vicinity of client apparatus 530 or otherwise being located at a distance at which client apparatus 530 receives spoofing signals 18. It follows that spoofer apparatus 40 may have a broadcast range within which various client apparatuses 530 receive spoofing signals 18 at a signal strength high enough to cause the various client apparatuses 530 to obtain an inaccurate GNSS-based location estimate. In various example embodiments, a system apparatus 20 implementing machine learning models may receive more than one requests for trustworthiness information from more than one client apparatuses 530 in a broadcast range of a spoofer apparatus 40. In such embodiments, the system apparatus 20 may adjust various parameters such as distance criteria, distance thresholds, threshold access point counts, threshold access point fractions, and/or the like, based on the trustworthiness of a subset of the GNSS-based location estimates received.

It will be appreciated that the example embodiments in the present disclosure bring technical advantages to the field. First, a system apparatus 20, instead of a client apparatus 30, may determine the trustworthiness of a GNSS-based location estimate (e.g., location 526 or location 528), where the system apparatus 20 may be a cloud-based computing system. As a result, no communication between the client apparatus 30 and the access point database 6 is explicitly necessary, no additional processing is required by the client apparatus 30, and the client apparatus 30 may conserve computing and processing power. However, in an example embodiment, the client apparatus 30, such as a client apparatus 30D in FIG. 4, may also be capable and configured to determine the trustworthiness of a GNSS-based location estimate (e.g., location 526 or location 528). For example, a client apparatus 30, such as a client apparatus 30D, capable of determining the trustworthiness of a GNSS-based location estimate may be preferred when communication between the client apparatus 30 and a system apparatus 20 (e.g., a cloud-based computing system) may be inconsistent or unreliable. In an example embodiment, a client apparatus 30D capable of determining the trustworthiness of a GNSS-based location estimate may verify trustworthiness information provided by a system apparatus 20 by providing its own trustworthiness information.

Furthermore, it will be appreciated that the system apparatus 20 evaluates network access points 504 based on distance criteria, rather than for example, calculating a network-based location estimate and comparing the two location estimates. The present disclosure provides methods of determining the trustworthiness of a GNSS-based location estimate (e.g., location 526 or location 528) that may be faster and more efficient than obtaining a network-based location estimate and comparing the network-based location estimate with a GNSS-based location estimate. As such, further computing and processing power by the system apparatus 20 may be conserved, and trustworthiness evaluation of the GNSS-based location estimate may be performed faster.

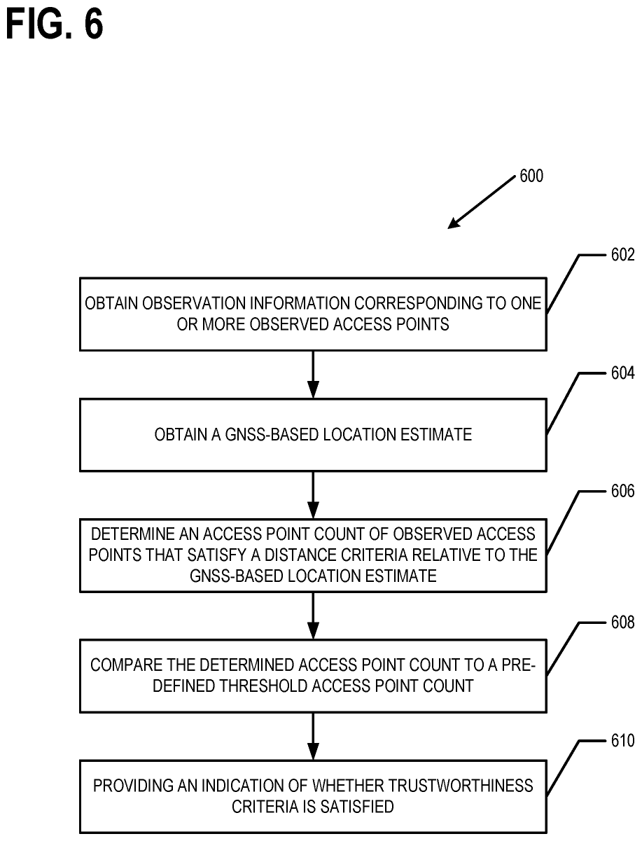

FIG. 6 provides a flowchart providing an example process 600 for evaluation trustworthiness of a GNSS-based location estimate. Example process 600 may be performed by a processor, such as processor 21 of system apparatus 20, one or more processors 21 of system apparatus 20 where system apparatus 20 may be a cloud-based computing system, a processor of spoofing detection circuitry 25 of system apparatus 20, a processor of spoofing detection circuitry 35 of client apparatus 30, and/or a processor 31 of client apparatus 30.

The process 600 begins at step/operation 602, where a processor obtains observation information corresponding to one or more observed access points. For example, the system apparatus 20 and/or a client apparatus 30 obtains observation information corresponding to one or more observed access points. For example, the system apparatus 20 and/or the client apparatus 30 comprises means, such as processor 21, 31, memory 22, 32, communication interface 23, 33, spoofing detection circuitry 25, 35, and/or the like, for obtaining observation information corresponding to one or more observed access points. For example, a computing device, such as a client device, provides (e.g., transmits) observation information and the system apparatus 20 receives the observation information (e.g., via a communication interface 23). In another example, a computing device, such as a client device, accesses the observation information from memory 32. In yet another example, the system apparatus 20 obtains (e.g., receives) observation information transmitted by a computing device.

The one or more observed access points are network access points 504 observed by a computing device, such as client apparatus 30, during a time period. The observed access points may comprise one or more Wi-Fi access points, one or more cellular network (e.g., 2G, 3G, 4G, LTE, WCDMA, 5G, NB-IoT, Cat M1) access points, one or more Bluetooth access points, and/or one or more other types of access points. The observation information may comprise identifiers for each of the one or more observed access points. For example, the observation information may comprise a media access control (MAC) address for each of one or more observed Wi-Fi access points, a cell ID for each of one or more observed cellular network access points, and/or a universally unique identifier (UUID) for each of one or more observed Bluetooth access points. In an example embodiment, the length of the time period may be determined based on movement information describing movement of the computing device during the time period. In an example embodiment, the length of the time period may be determined based on one or more location accuracy requirements of an application operating on and/or being executed by the computing device. In an example embodiment, the observation information also includes movement information corresponding to and/or indicating a motion state and/or otherwise describing the movement of the computing device during at least a portion of the time period. For example, the movement information is captured and/or generated by one or more sensors in communication with the computing device and/or physically associated with the computing device (e.g., accelerometers, gyroscopes, IMU sensors, cameras, radar, lidar, and/or the like).

Step/operation 602 may be followed by step/operation 604, where a processor obtains a GNSS-based location estimate. For example, the system apparatus 20 and/or a client apparatus 30 obtains a GNSS-based location estimate. For example, the system apparatus 20 and/or the client apparatus 30 comprises means, such as processor 21, 31, memory 22, 32, communication interface 23, 33, spoofing detection circuitry 25, 35, GNSS receiver 36, and/or the like, for obtaining a GNSS-based location estimate corresponding to the estimated location of the computing device. For example, a computing device, such as a client device, provides (e.g., transmits) the GNSS-based location estimate indicating an estimated location of the computing device and the system apparatus 20 receives the GNSS-based location estimate (e.g., via a communication interface 23). In another example, a computing device, such as a client device, accesses the GNSS-based location estimate from memory 32. In yet another example, a system apparatus 20 may receive a GNSS-based location estimate transmitted by a computing device.

The GNSS-based location estimate indicates an estimated location of the computing device during at least a portion of the time period. In various example embodiments, the GNSS-based location estimate is determined by a GNSS sensor of the computing device. In various example embodiments, an application operating on and/or being executed by the computing device triggers the computing device to provide the observation information and the GNSS-based location estimate such that the processor obtains the observation information and the GNSS-based location estimate. In various example embodiments, the processor is part of a cloud-based computing system (e.g., system apparatus 20) and the observation information and the GNSS-based location estimate are obtained via an application program interface (API) call generated by the computing device (e.g., client apparatus 30).

Following step/operation 604, step/operation 606 may be performed, where a processor determines an access point count corresponding to a number of the one or more observed access points that satisfy a distance criteria relative to the GNSS-based location estimate. For example, the system apparatus 20 and/or a client apparatus 30 determines an access point count corresponding to a number of the one or more observed access points that satisfy a distance criteria relative to the GNSS-based location estimate. For example, the system apparatus 20 and/or the client apparatus 30 comprises means, such as processor 21, 31, memory 22, 32, communication interface 23, 33, spoofing detection circuitry 25, 35, and/or the like, for determining an access point count corresponding to a number of the one or more observed access points that satisfy a distance criteria relative to the GNSS-based location estimate. In various example embodiments, the distance criteria corresponds to the respective distance of a respective access point of the one or more observed access points from the GNSS-based location estimate being less than a distance threshold. In various example embodiments, the distance threshold may be determined based on movement information (e.g., obtained in association with the observation information, for example) describing movement of the computing device during the time period. In various example embodiments, the distance threshold may be determined for each access point of the one or more access points independently based on when during the time period the access point was observed by the computing device. In various example embodiments, a location of an access point of the one or more observed access points is determined by accessing an access point database storing locations of a plurality of access points in association with respective observables that may be used to identify a corresponding access point of the plurality of access points.

Process 600 may then continue to step/operation 608, where a processor compares the determined access point count to a pre-defined threshold access point count. For example, the system apparatus 20 and/or the client apparatus 30 compares the determined access point count to a pre-defined threshold access point count. For example, the system apparatus 20 and/or a client apparatus 30 comprise means, such as processor 21, 31, memory 22, 32, communication interface 23, 33, spoofing detection circuitry 25, 35, and/or the like, for comparing the determined access point count to a pre-defined threshold access point count. In various example embodiments, comparing the determined access point count to a pre-defined threshold access point count comprises determining an access point fraction based at least in part on a fraction defined by the number of the one or more observed access points that satisfy a distance criteria relative to the GNSS-based location estimate divided by the total number of one or more observed access points, and comparing the determined access point fraction to a pre-defined threshold fraction. In various example embodiments, the pre-defined threshold access points count is determined based on one or more location accuracy requirements of an application operating on and/or being executed by the processor.

Step/operation 608 may be followed by step/operation 610, where a processor provides an indication of whether or not the GNSS-based location estimate is trustworthy based on results of the comparison in step/operation 608. For example, the system apparatus 20 and/or a client apparatus 30 provides an indication of whether or not the GNSS-based location estimate is trustworthy based on results of the comparison in step/operation 608. For example, the system apparatus 20 and/or the client apparatus 30 comprises means, such as processor 21, 31, memory 22, 32, communication interface 23, 33, spoofing detection circuitry 25, 35, and/or the like, for providing an indication of whether or not the GNSS-based location estimate is trustworthy. For example, the system apparatus 20 comprises a communication interface 23 for providing (e.g., transmitting) an indication of whether or not the GNSS-based location estimate is trustworthy to a client apparatus 30. For example, the client apparatus 30 comprises a user interface 34 for providing (e.g., displaying) an indication of whether or not the GNSS-based location estimate is trustworthy to a user. In various example embodiments, the indication of whether or not the GNSS-based location estimate is trustworthy may be at least one of (a) a binary indication of whether or not the GNSS-based location estimate is trustworthy, or (b) a trustworthiness score indicating a determined confidence in the trustworthiness of the GNSS-based location estimate. In various example embodiments, the indication of whether or not the GNSS-based location estimate is trustworthy may be configured to be used to determine whether the GNSS-based location estimate may be used (e.g., by the application operating on and/or being executed by the computing device) to perform one or more positioning and/or navigation-related functions.

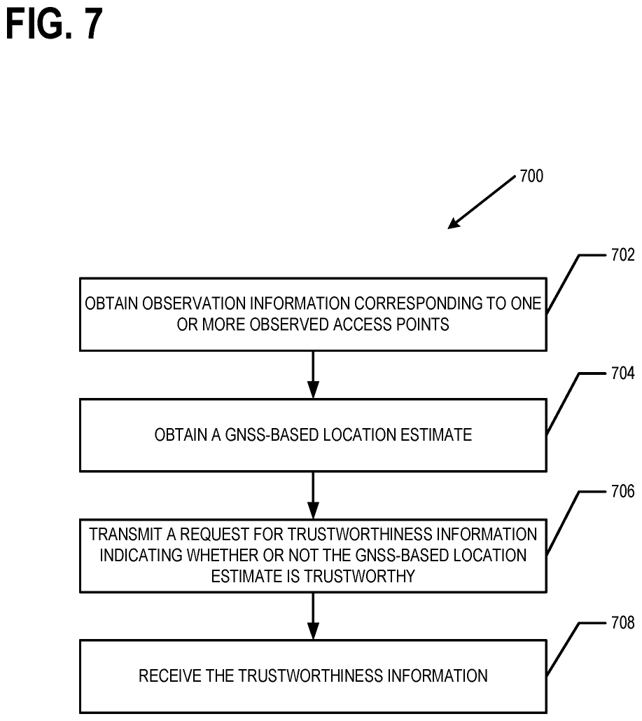

Referring now to FIG. 7, a flowchart illustrating an example process 700 for evaluating trustworthiness of a GNSS-based location estimate is provided. Process 700 may begin at step/operation 702, where a computing device obtains observation information corresponding to one or more access points observed by the computing device during a time period. For example, a client apparatus 30 obtains observation information corresponding to one or more access points observed during a time period. For example, the client apparatus 30 comprises means, such as processor 31, memory 32, communication interface 33, user interface 34, spoofing detection circuitry 35, and/or the like, for obtaining observation information corresponding to one or more access points observed during a time period. For example, a computing device, such as a client device, is configured to actively scan available frequencies for access points and be further configured to record, write, and/or store observation information based at least in part on response frames from access points. In another example, a computing device, such as a client device, accesses or retrieves observation information from memory 32. In another example, a computing device, such as a client device, receives observation information from a user via user interface 34.

Step/operation 702 may be followed by step/operation 704, where the computing device obtains a GNSS-based location estimate indicating an estimated location of the computing device during at least a portion of the time period. For example, a client apparatus 30 obtains a GNSS-based location estimate indicating an estimated location of the client apparatus 30 during at least a portion of the time period. For example, the client apparatus 30 comprises means, such as processor 31, memory 32, communication interface 33, user interface 34, spoofing detection circuitry 35, GNSS receiver 36, and/or the like, for obtaining a GNSS-based location estimate. For example, a computing device, such as a client device, is configured to calculate or determine a GNSS-based location estimate based at least in part on signals received by GNSS receiver 36. In another example, a computing device, such as a client device, accesses or retrieves a GNSS-based location estimate from memory 32. In another example, a computing device, such as a client device, receives a GNSS-based location estimate from a user via user interface 34.

Process 700 may then continue to step/operation 706, where the computing device (e.g., client apparatus 30) provides (e.g., transmits) a request for trustworthiness information such that a cloud-based computing system (e.g., system apparatus 20) receives the request. In various embodiments, the request includes at least a portion of the observation information and the GNSS-based location estimate. For example, a client apparatus 30 transmits a request for trustworthiness information such that a cloud-based computing system receives the request. For example, the client apparatus 30 comprises means, such as processor 31, memory 32, communication interface 33, user interface 34, spoofing detection circuitry 35, and/or the like for transmitting a request for trustworthiness information, including at least a portion of the observation information and the GNSS-based location estimate. For example, a computing device is configured to retrieve (e.g., from memory 32) at least a portion of the observation information and the GNSS-based location estimate, generate a request for trustworthiness information comprising at least the portion of the observation information and the GNSS-based location estimate, and transmit (e.g., via communication interface 33) the request. For example, a computing device is configured to transmit the trustworthiness information in the form of an online API call. For example, a cloud-based computing system, such as system apparatus 20, comprises a communication interface 23 configured to receive data, such as a request for trustworthiness information, transmitted by a computing device (e.g., via communication interface 33).

Step/operation 708 may then be performed, where in response to the request, the computing device receives, from the cloud-based computing system, the trustworthiness information, wherein the trustworthiness information is based at least in part on a comparison of (i) an access point count corresponding to a number of the one or more observed access points that satisfy a distance criteria relative to the GNSS-based location estimate, to (ii) a pre-defined threshold access point count. For example, a client apparatus 30 receives the trustworthiness information in response to the request transmitted in step/operation 706. For example, the client apparatus 30 comprises means, such as processor 31, memory 32, communication interface 33, user interface 34, spoofing detection circuitry 35, and/or the like for receiving the trustworthiness information. For example, the cloud-based computing system comprises communication interface 23 configured to transmit the trustworthiness information, and the computing device, such as a client device, comprises communication interface 33 configured to receive the trustworthiness information. For example, the cloud-based computing system provides the trustworthiness information in a secure online location accessible to the computing device, and the computing device comprises means for retrieving the trustworthiness information from the secure online location. In another example, the computing device is configured to receive the trustworthiness information in the form of an online API response.

### III. Technical Advantages

Various embodiments of the present disclosure provide significant technical advantages in the field. As aforementioned, embodiments of the present disclosure provide methods, apparatuses, and computer program products for determining the trustworthiness of a GNSS-based location estimate. For many online applications and services, the location of a client device and/or a user is critical information. For example, an online service may be modified based on a specific location of a client device and/or a user, or could be restricted in other locations. As another example, an online navigation application constantly and/or periodically requires the location of a client device and/or user in order to safely and accurately provide navigational information. In these examples and many more instances, the need for trustworthy location information exists.

The embodiments of the present disclosure provide a rapid and efficient method for determining the trustworthiness of a GNSS-based location estimate without compromising accuracy, specificity, or sensitivity. Specifically, the embodiments of the present disclosure leverage at least one positioning modality different from GNSS positioning to quickly identify if a GNSS-based location estimate may be inaccurate. As mentioned in the present disclosure, embodiments may reference and/or access various network positioning databases, such as a Wi-Fi positioning databases, cellular network positioning databases, and Bluetooth network positioning databases. Leveraging other positioning modalities is done efficiently in embodiments of the present disclosure, where embodiments may obtain observation information relating to network access points, determine an access point count of network access points satisfying distance criteria relative to a GNSS-based location estimate by at least referencing a network positioning database, and compare the access point count to a threshold count to determine the trustworthiness of a GNSS-based location estimate. Such embodiments may arrive at a trustworthiness conclusion faster than embodiments where a separate network-based location estimate is obtained and compared with a GNSS-based location estimate, due to at least the calculations and processing needed to obtain such a separate network-based location estimate. In other words, embodiments of the present disclosure may determine a consistency between a GNSS positioning system and at least one different network positioning system.

Furthermore, embodiments of the present disclosure may be at least partially implemented and/or performed by a cloud-based computing system. For example, a cloud-based computing system is in communication with a computing device, such as a client device, and obtains observation information corresponding to one or more access points observed by the computing device during a time period, obtains a GNSS-based location estimate indicating an estimated location of the computing device during at least a portion of the time period, determines an access point count corresponding to a number of the one or more observed access points that satisfy a distance criteria relative to the GNSS-based location estimate, compares the determined access point count to a pre-defined threshold access point count, and based on results of the comparison, provides an indication of whether or not the GNSS-based location estimate is trustworthy. Here, embodiments of the present disclosure provide technical advantages by conserving processing and computing power of a computing device due to a cloud-based computing system determining the trustworthiness of a GNSS-based location estimate on the behalf of the computing device. Furthermore, various embodiments may be in communication and/or access an access point database, which may be more efficiently achieved by a cloud-based computing system. In various embodiments, the cloud-based computing system may comprise the access point database. In such embodiments, memory storage space of the computing device is conserved, as the computing device does not need to store any portion of the access point database.

In various example embodiments of the present disclosure, a cloud-based computing system being configured to determine the trustworthiness of a GNSS-based location estimate provides a technical advantage of accumulating large amounts of data to train machine learning models. A cloud-based computing system may be configured to determine the trustworthiness of GNSS-based location estimates for a plurality of computing devices, such as client devices. While determining the trustworthiness of GNSS-based location estimates for a plurality of clients, a cloud-based computing system may aggregate data in order to adjust various parameters such as distance criteria and threshold access point counts and fractions. In various embodiments, spoofing may be targeted at multiple client apparatuses within a specific area (e.g., a city block), and based on aggregation of data from multiple client apparatuses and a machine learning model, a cloud-based computing system may adjust various parameters for trustworthiness determination specific to the specific area under a spoofing attack. Thus, embodiments of the present disclosure where a cloud-based computing system is configured to determine the trustworthiness of GNSS-based location estimates may, over time, improve accuracy while lowering the rate of false positives and the negative predictive value.

Meanwhile however, embodiments of the present disclosure may be at least partially implemented and/or performed by a computing device. For example, a computing device obtains observation information corresponding to one or more access points observed by the computing device during a time period, obtains a GNSS-based location estimate indicating an estimated location of the computing device during at least a portion of the time period, determines an access point count corresponding to a number of the one or more observed access points that satisfy a distance criteria relative to the GNSS-based location estimate, compares the determined access point count to a pre-defined threshold access point count, and based on results of the comparison, provides an indication of whether or not the GNSS-based location estimate is trustworthy. In such embodiments, the computing device being configured to determine a trustworthiness of a GNSS-based location estimate provides a technical advantage of mobility and versatility in situations where the computing device may not be able to communicate with a cloud-based computing system configured to determine a trustworthiness of a GNSS-based location estimate. For example, the computing device may comprise significant processing power and being configured to determine the trustworthiness of a GNSS-based location estimate may eliminate at least a portion of time needed to transmit a request for trustworthiness information, observation information, and a GNSS-based location estimate to a cloud-based computing system.

### IV. Example Apparatus

The system apparatus 20 and/or the client apparatus 30 of an example embodiment may be embodied by or associated with a variety of computing devices including, for example, a navigation system including a global navigation satellite system (GNSS), a cellular telephone, a mobile phone, a personal digital assistant (PDA), a watch, a camera, a computer, an Internet of things (IoT) item, and/or other device that can observe the radio environment (e.g., the cellular radio environment) in the vicinity of the computing device and/or that can store at least a portion of a positioning map. Additionally or alternatively, the system apparatus 20 and/or the client apparatus 30 may be embodied in other types of computing devices, such as a server, a personal computer, a computer workstation, a laptop computer, a plurality of networked computing devices or the like, that are configured to obtain observation information corresponding to one or more access points observed by a computing device during a time period, obtain a GNSS-based location estimate indicating an estimated location of the computing device during at least a portion of the time period, determine an access point count corresponding to a number of the one or more observed access points that satisfy a distance criteria relative to the GNSS-based location estimate, compare the determined access point count to a pre-defined threshold access point count, and based on results of the comparison, providing an indication of whether or not the GNSS-based location estimate is trustworthy, and/or the like. Additionally or alternatively, the system apparatus 20 and/or the client apparatus 30 may be embodied in other types of computing devices that are configured to obtain observation information corresponding to one or more access points observed by the computing device during a time period, obtain a GNSS-based location estimate indicating an estimated location of the computing device during at least a portion of the time period, transmit, to a cloud-based computing system, a request for trustworthiness information indicating whether or not the GNSS-based location estimate is trustworthy, the request including at least a portion of the observation information and the GNSS-based location estimate, and in response to the request, receive, from the cloud-based computing system, the trustworthiness information, wherein the trustworthiness information is based at least in part on a comparison of (i) an access point count corresponding to a number of the one or more observed access points that satisfy a distance criteria relative to the GNSS-based location estimate, to (ii) a pre-defined threshold access point count, and/or the like. In an example embodiment, a client apparatus 30 is a smartphone, tablet, laptop, vehicle navigation system, and/or other mobile computing device and a system apparatus 20 is a server that may be part of a Cloud-based processing system.

In some embodiments, the processor 21, 31 (and/or co-processors or any other processing circuitry assisting or otherwise associated with the processor) may be in communication with the memory device 22, 32 via a bus for passing information among components of the apparatus. The processor 21, 31 may communicate with other components of system apparatus 20 and/or client apparatus 30, respectively, via a bus. For example, the processor 31 communicates with a GNSS receiver 36 to obtain a GNSS-based location estimate. For example, the processor 31 communicates with a movement sensor 37 to obtain movement information. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. For example, the memory device could be configured to store distance, trustworthiness criteria, and trustworthiness determination logic for processing by the processor. Additionally or alternatively, the memory device could be configured to store instructions for execution by the processor.

As described above, the system apparatus 20 and/or client apparatus 30 may be embodied by a computing entity and/or device. However, in some embodiments, the system apparatus 20 and/or client apparatus 30 may be embodied as a chip or chip set. In other words, the system apparatus 20 and/or client apparatus 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The system apparatus 20 and/or client apparatus 30 may therefore, in some cases, be configured to implement an embodiment of the present invention on a single chip or as a single “system on a chip.” As such, in some cases, a chip or chipset may constitute means for performing one or more operations for providing the functionalities described herein.

The processor 21, 31 may be embodied in a number of different ways. For example, the processor 21, 31 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 21, 31 may include one or more processing cores configured to perform independently. A multi-core processor may enable multiprocessing within a single physical package. Additionally or alternatively, the processor 21, 31 may include one or more processors configured in tandem via the bus to enable independent execution of instructions, pipelining and/or multithreading.

In an example embodiment, the processor 21, 31 may be configured to execute instructions stored in the memory device 22, 32 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the client apparatus 30 may optionally include a user interface 34 that may, in turn, be in communication with the processor 31 to provide output to the user, such as a GNSS-based location estimate in the context of a map, an indication of the trustworthiness, or trustworthiness information, of a GNSS-based location estimate, one or more navigable routes to a destination location and/or from an origin location, display of location dependent and/or triggered information, and/or the like, and, in some embodiments, to receive an indication of a user input. As such, the user interface 34 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 31 (e.g., memory device 32 and/or the like). In some example embodiments, the system apparatus 20 may optionally include a user interface.

The system apparatus 20 and/or client apparatus 30 may optionally include a communication interface 23, 33. The communication interface 23, 33 may be any means such as a device or circuitry embodied in either hardware or a combination of hardware and software that is configured to receive and/or transmit data from/to a network and/or any other device or module in communication with the system apparatus 20 and/or the client apparatus 30. For example, communication interface 23 included in system apparatus 20 comprises means configured to receive and/or transmit data from/to an access point database 6. For example, a communication interface 23 included in system apparatus 20 is configured to receive observation information and a GNSS-based location estimate and provide (e.g., transmit) an indication of trustworthiness of the GNSS-based location estimate. For example, a communication interface 33 included in client apparatus 30 is configured to provide (e.g., transmit) a request for trustworthiness information comprising at least a portion of observation information and a GNSS-based location estimate and receive trustworthiness information. In this regard, the communication interface 23, 33 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a system apparatus 20 and/or client apparatus 30 may comprise a component (e.g., memory 22, 32, and/or another component) that stores a digital map (e.g., in the form of a geographic database) comprising a first plurality of data records, each of the first plurality of data records representing a corresponding TME, wherein at least some of said first plurality of data records map information/data indicating current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location) to a point on a map, a lane of a lane network, and/or link, one or more localization features and a corresponding location of each localization feature, and/or the like. For example, the geographic database may comprise a positioning map comprising instances of neighbor-cell information that are each comprising, associated with, and/or indexed by a respective globally unique identifier. For example, a geographic database may include road segment, segment, link, lane segment, or traversable map element (TME) data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the system apparatus 20 and/or client apparatus 30 may be configured to modify, update, and/or the like one or more data records of the geographic database. For example, the system apparatus 20 and/or the client apparatus 30 may modify, update, generate, and/or the like map information/data corresponding to TMEs, links, lanes, road segments, travel lanes of road segments, nodes, intersection, pedestrian walkways, elevators, staircases, and/or the like and/or the corresponding data records (e.g., to add or update updated map information/data including, for example, current traffic conditions along a corresponding TME), a localization layer (e.g., comprising localization features) and/or the corresponding data records, and/or the like, based at least in part on an indicated trustworthiness of a GNSS-based location estimate.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively and/or additionally, the geographic database can contain navigable aerial route segments or nodes and connection information/data or other data that represent an navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. Data about the respective locations of the POIs may be generated based at least in part on trustworthy GNSS-based location estimates. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. For example, field personnel traveling by vehicle may record data such as GNSS-based location estimates. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases. Regardless of the manner in which the databases are compiled and maintained, a system apparatus 20 and/or client apparatus 30 in accordance with an example embodiment may generate the databases (e.g., a positioning map) comprising instances of neighbor-cell information that are each comprising, associated with, and/or indexed by a respective globally unique identifier and/or use the databases (e.g., the positioning map) to perform one or more positioning and/or navigation-related functions.

### V. Apparatus, Methods, and Computer Program Products

As described above, FIGS. 6 and 7 illustrate flowcharts of a system apparatus 20 and/or client apparatus 30, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 22, 32 of an apparatus employing an embodiment of the present invention and executed by the processor 21, 31 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
obtaining, by a processor, observation information corresponding to one or more access points observed by a computing device during a time period;
obtaining, by the processor, a GNSS-based location estimate indicating an estimated location of the computing device during at least a portion of the time period;
determining, by the processor, an access point count corresponding to a number of the one or more observed access points that satisfy a distance criteria relative to the GNSS-based location estimate;
comparing, by the processor, the determined access point count to a pre-defined threshold access point count; and
based on results of the comparison, providing, by the processor, an indication of whether or not the GNSS-based location estimate is trustworthy.

2. The method of claim 1, wherein the one or more access points comprise at least one of:
one or more Wi-Fi access points and the observation information comprises a media access control (MAC) address for each of the one or more Wi-Fi access points,
one or more cellular network access points and the observation information comprises a cell ID, or
one or more Bluetooth access points and the observation information comprises a universally unique identifier (UUID).

3. The method of claim 1, wherein comparing the determined access point count to a pre-defined threshold access point count comprises:
determining an access point fraction based at least in part on a fraction defined by the number of the one or more observed access points that satisfy a distance criteria relative to the GNSS-based location estimate divided by the total number of one or more observed access points; and
comparing the determined access point fraction to a pre-defined threshold fraction.

4. The method of claim 1, wherein the distance criteria corresponds to the respective distance of a respective access point of the one or more observed access points from the GNSS-based location estimate being less than a distance threshold.

5. The method of claim 1, wherein at least one of the distance threshold or a length of the time period is determined based on movement information describing movement of the computing device during the time period.

6. The method of claim 5, wherein the distance threshold is determined for each access point of the one or more access points independently based on when during the time period the access point was observed by the computing device.

7. The method of claim 5, wherein the movement information is determined based on sensor data captured by one or more sensors of the computing device.

8. The method of claim 1, wherein a location of an access point of the one or more observed access points is determined by accessing an access point database storing locations of a plurality of access points in association with respective observables that may be used to identify a corresponding access point of the plurality of access points.

9. The method of claim 1, wherein the processor is part of a cloud-based computing system and wherein the observation information and the GNSS-based location estimate is obtained via an application program interface (API) call generated by the computing device.

10. The method of claim 1, wherein the GNSS-based location estimate is determined by a GNSS sensor of the computing device.

11. The method of claim 1, wherein the processor is part of the computing device.

12. The method of claim 1, wherein the indication of whether or not the GNSS-based location estimate is trustworthy is at least one of (a) a binary indication of whether or not the GNSS-based location estimate is trustworthy, or (b) a trustworthiness score indicating a determined confidence in the trustworthiness of the GNSS-based location estimate.

13. The method of claim 1, wherein an application operating on the computing device triggers the computing device to provide the observation information and the GNSS-based location estimate such that the processor obtains the observation information and the GNSS-based location estimate.

14. The method of claim 13, wherein at least one of (a) a length of the time period, (b) the distance criteria, or (c) the pre-defined threshold access point count is determined based on one or more location accuracy requirements of the application.

15. The method of claim 1, wherein the indication of whether or not the GNSS-based location estimate is trustworthy is configured to be used to determine whether the GNSS-based location estimate may be used to perform one or more positioning and/or navigation-related functions.

16. A method comprising:
obtaining, by a computing device, observation information corresponding to one or more access points observed by the computing device during a time period;
obtaining, by the computing device, a GNSS-based location estimate indicating an estimated location of the computing device during at least a portion of the time period;
transmitting, by the computing device to a cloud-based computing system, a request for trustworthiness information indicating whether or not the GNSS-based location estimate is trustworthy, the request including at least a portion of the observation information and the GNSS-based location estimate; and
in response to the request, receiving, by the computing device from the cloud-based computing system, the trustworthiness information, wherein the trustworthiness information is based at least in part on a comparison of (i) an access point count corresponding to a number of the one or more observed access points that satisfy a distance criteria relative to the GNSS-based location estimate, to (ii) a pre-defined threshold access point count.

17. The method of claim 16, wherein the one or more access points comprise at least one of:
one or more Wi-Fi access points and the observation information comprises a media access control (MAC) address for each of the one or more Wi-Fi access points,
one or more cellular network access points and the observation information comprises a cell ID, or
one or more Bluetooth access points and the observation information comprises a universally unique identifier (UUID).

18. The method of claim 16, wherein the trustworthiness information comprises at least one of (a) a binary indication of whether or not the GNSS-based location estimate is trustworthy, or (b) a trustworthiness score indicating a determined confidence in the trustworthiness of the GNSS-based location estimate.

19. The method of claim 16, wherein the transmitting, by the computing device to a cloud-based computing system, a request for trustworthiness information is triggered by an application operating on the computing device.

20. A system, comprising one or more servers each comprising at least one memory and at least one processor, the at least one memory storing instructions that, when executed by the at least one processor, cause the system to:
obtain observation information corresponding to one or more access points observed by a computing device during a time period;
obtain a GNSS-based location estimate indicating an estimated location of the computing device during at least a portion of the time period;
determine an access point count corresponding to a number of the one or more observed access points that satisfy a distance criteria relative to the GNSS-based location estimate;
compare the determined access point count to a pre-defined threshold access point count; and
based on results of the comparison, provide an indication of whether or not the GNSS-based location estimate is trustworthy.
